(19) United States
(12) Patent Application Publication
(10) Pub. No.: US 2003/0017294 A1
(43) Pub. Date: Jan. 23, 2003

(54) Tape edging for pliable adhesion/coding of products

(76) Inventors: Scott MacDonell, Aptos, CA (US); Mark Fakunding, Aptos, CA (US)

Correspondence Address: Scott MacDonell, P.O. Box 1775, Aptos, CA, 95001, US

(21) Appl. No.: 09/800,639

(22) Filed: Mar. 7, 2001

Related U.S. Application Data
(60) Provisional application No. 60/238,860, filed on Oct. 7, 2000.

(51) Int. Cl. B32B 33/00

(52) U.S. Cl. 428/42.2; 428/40.1

(57) ABSTRACT

A thin tape edging for blueprints/products and of the type having on one side a squared notch (18) down the center perpendicularly which exposes an adhesive layer, (10) created by two adjacent bordering strips of peel-off laminate, the opposite of said tape is formulated of non-adhesive backing material. The backing, (20) the adhesive layer (10) and the peel-off laminate strips (16) should be made of a flexible material so that it can be repeatedly bent/rolled, without fracturing, along an axis aligned with said notch (18). In addition, the notch should act as a hinge to facilitate the uniform wrap along the vertical edge (22) of the blueprint/product. The backing should be of colored hues so as to act as visual cues for accessibility/sight recognition. The backing should be of a texture that gives it a easy grasping surface (20).

### CROSS-REFERENCE TO RELATED APPLICATIONS

Claim primarily from provisional patent application No. 60/238,860 filed Oct. 7, 2000, the disclosure of which is expressly incorporated herein by reference. Pertains to blueprints and other products, which need stability, flexibility and/or sight recognition along the vertical edges for easier handling and usability. Pre-colored to provide quick accessibility & reference.

### BACKGROUND

1. Field of Invention

This invention relates to pre-cut adhesion tape sectionals to provide weight and flexibility, best applications to the edges of blueprints in order to prevent tears caused by inclement weather, rough handling and to quickly access various production segments through color-coding. Because of the taping process's flexibility, blueprints can be rolled/unrolled just as securely as an original set of plans.

2. Description of Prior Art

U.S. Pat. No. 6,025,045 to Langeman (2000) discloses an edging process that utilizes tape which is used during the coating of a product to allow it to dry or cure, suggesting a process for paint trimming and/or the need to mask a product rather than add to it's usefulness. Also, Langeman's edging does not create a pre-defined notch in which to identify the bent of the tape or the peel-off laminate that will leave one side unexposed until the other side is secured.

Another invention, U S. Application 933,233 issued to Baumann (1997) discloses a identification system for the exterior of rolled blueprints utilizing an attachment of a distended bulb attachment, with an self stick adhesive secured to the bulb as opposed to adhering directly to the blueprint/product and is only intended for use for the overall identification of the cylindrical roll as opposed to separate segments of the production phases inherent in blueprints.

Lastly, U.S. Pat. No. 6,001,200 issued to Hibler, (1998) is an edge protector method and system for protecting an outside corner, e.g., of a room, which corner is formed by two walls or faces. The novel tape for protecting such outside corner is formed from polymeric material desirably having a thickness of from about 5 to 20 mils and which is formed from a pair of sides with an interconnecting hinge, said sides formed from a relatively stiff polymeric material compared to said hinge which is formed from a relatively flexible and elastic polymeric material compared to said sides, said hinge preferably being accurate in shape, said tape having a front surface and a rear surface which is coated with a pressure sensitive adhesive. While this patent roughly approximates the utilization of our invention, it does not pertain to rolled documentation, nor does it address color coding for different segments of blueprint construction phases.

### SUMMARY

In accordance with this invention a tape adhesion strip preferably comprises a width of ¾ inch to 1½ inch of flat tape, a layer of paper peel-off laminate, notched in the center, covering the adhesive outward to both edges of the tape, leaving 1/16^{th}-⅛^{th} inch exposed adhesion within the notch, for example. The notch is created by the effect of the two borders from two peel-off pieces of laminate paper extending to the edges of the adhesive outward facing of the tape. This notch will act as a hinge in order to provide a consistent fold to both horizontal sides of product to be edged. Various solid & multi colored backing will coat the non-adhesive side to provide color-coding and supply a non-slip surface.

Objects and Advantages

Accordingly, besides the objects and advantages of the taping bindings described in the above patent, several objects and advantages of the present invention are:

(a) to provide a flexible sturdy light-weight taping process which can be produced in production rolls and then precut at a relative small cost. The production of the standard five colors (red, blue, yellow, white and green) would be minimal in regard to the commercial return.

(b) to provide a standardized taping process that becomes beneficial and is needed in the construction industry.

(c) to provide a taping process which is flexible, durable and brightly colored.

(d) to provide a weighted edge that will aid in the reduction of blueprint costs and aid in time-management through color-coded tabbing.

(e) to provide a taping process that has not been introduced into the marketplace.

(f) to provide a marketing tool for like-minded businesses, i.e.; construction rentals, building materials, safety mottos, etc.

(g) to provide a taping process that will repel the adverse conditions of the weather and usage, i.e., wind, rough handling, etc., with weight and stability.

(h) to provide a rough-edged gripping surface to easily manipulate pages and large forms, and

(i) to provided precut sets to ensure that all segments of a plan have the ability to be color coded and wrapped in one application.

Further objects and advantages are to provide a taping process that can be used easily and applied quickly, precut so that they are easily available to individuals and/or foreman to use. A process that is simple and inexpensive to manufacture, that can be sold either in multi-colored packs or a single colored packs. Rolls can be manufactured as well in solid colors that have breakaway sections, measured and precut to dimensional lengths. Still further objects and advantages will become apparent from a consideration of the ensuing description and drawings.

### DRAWING FIGURES

In the drawings, closely related figures have the same number but different alphabetic suffixes.

FIG. 1A shows a top view of a tape section, with two peel off laminate strips layered on top of the adhesive layer with a gap/notch showing the exposed adhesive, the backing comprising the bottom layer.

FIG. 1B shows a vertical side view of a tape section with the three layers, the backing flat surface, the adhesive body, and the two peel-off strips extending towards the center notch of exposed adhesion

FIG. 1C shows a similar tape section as in FIG. 1B bent forward at a 75% angle.

FIG. 1D shows a reversed image tape section as in FIG. 1B with peel-off paper lamination on both sides of the notch, adhesion layer and backing

FIG. 2 shows the tape section's three layers, the peel off lamination without a notch, the adhesive layer and the bottom layer of backing material.

FIG. 3 shows a similar tape section as in FIG. 2 with an exposed adhesive notch between the two strips of peel-off laminate, adhesive layer and exploded backing material.

FIG. 4 shows a similar tape section as in FIG. 2 with notch and peel-off laminate exploded back, the adhesive layer and the exploded backing material.

FIG. 5 shows a similar tape section as in FIG. 4 with the notch and peel-off laminate exploded back, the adhesive layer and the backing material layered on the bottom

FIG. 6A shows a vertical view of the tape section with the layer of peel-off laminate attached to the adhesive layer.

FIG. 6B shows a vertical view of the tape section as in FIG. 6A with the two layers of peel off laminate and adhesive layer, backing material and the horizontal edge of the target product prepared to be inserted into the adhesive notch.

FIG. 6C shows a vertical view of the tape section as in FIG. 6A with the two layers of peel off laminate and adhesive layer, the exposed adhesive notch and the horizontal edge of the target product prepared to be inserted into the adhesive notch.

FIG. 6D shows a vertical view of the tape section with the adhesive layer attached to the layer of backing material.

FIG. 7A shows a reversed 75% vertical angle of a tape section with the horizontal edge prepared to be inserted into notch of exposed adhesive, with peel-off laminate in place, the adhesive layer and the backing material, the target product intended to be inserted into the notch of exposed adhesion.

FIG. 7B shows a vertical view of a tape section of the adhesive layer and the two peel off laminate strips in place, the target product intended to be inserted into the notch of exposed adhesion.

FIG. 8 shows a tape section applied to one horizontal edge, bend at the notch along the products vertical edge, the laminate peel-off strip partially pulled back ready for adhesion onto the top horizontal surface of the product.

FIG. 8A shows a rolled up set of blueprints with the tape sections applied to the vertical edges of the ends.

FIG. 9 shows an exploded view of an enlarged tape section bent back ready for application to a product edge.

### REFERENCE NUMERALS IN DRAWINGS

10—Layer of adhesive rubber resin material and/or an adhering compound

16—Layer of peel-off laminate non-adhesive strip (s) and/of plastic, polymer or waxed material, etc.

18—Exposed center adhesive notch

20—Layer of non-skid backing substrate-saturated crepe paper and/or material of sufficient tensile strength and flexibility to be considered tape backing

22—Horizontal product edge, i.e., blueprint/paper vertical edge, etc.

Description—FIGS. 1A, 1B, 1C and 1D, 2, 3, 4, 5—Preferred Embodiment:

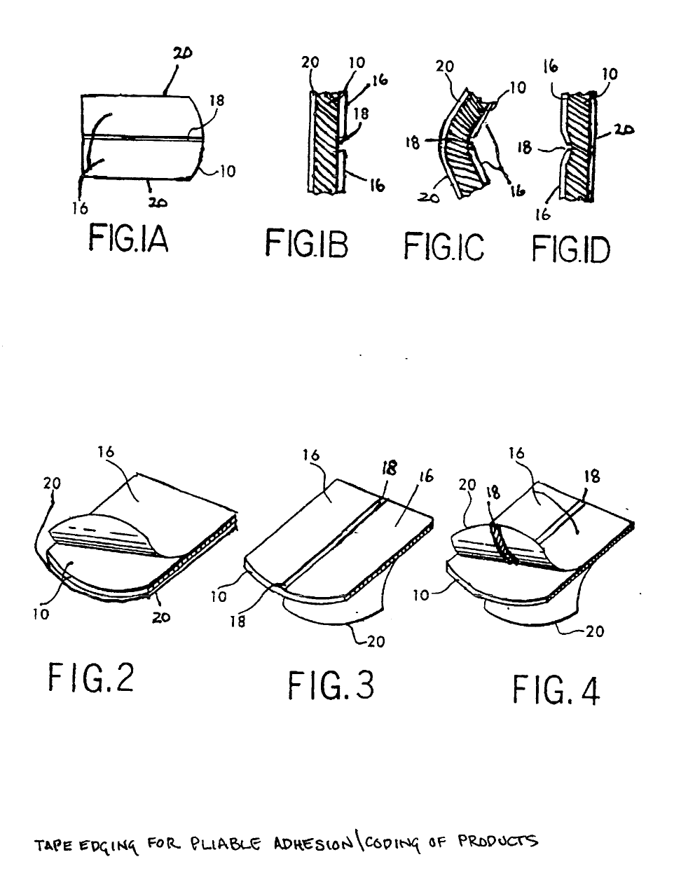

A preferred embodiment of the tape section of the type comprising a flat body of material having a center notch, exposing adhesive material, comprised by the effect of two borders from two peel-off pieces of laminate paper extending to the edges of the tape horizontally in FIG. 1A (top view) and FIG. 1B, 1C (left side views) and FIG. 1D (right side view). The opposite side of the said tape section will be non-adhesive and comprised of a flat surface. The tape section has three stratums, each consisting of a flexible material which can be repeatedly bent, rolled and straightened out without fracturing. The tape section (FIG. 2) is preferably comprised of three layers, the bottom layer 20 of non-adhesive saturated crepe paper and/or material of sufficient tensile strength and flexibility to be considered tape backing, semi-rough in texture. The center layer 10 comprised of adhesive, i.e., rubber resin and/or an adhering compound. The top layer 16 consisting of two peel-off laminate strips of non-adhesive substrate, i.e., two plastic, polymer or waxed strips that extend from the outer edges of the adhesive layer 10 towards the center (FIGS. 3, 4, 5), leaving a gap or notch 18 in which to insert a paper/product vertical edge to be wrapped on both sides, along the upper and lower horizontal edges of target product. In the preferred embodiment, the base 20 and center 10 and peel-off laminate strips 16 are of a flexible material. Crepe paper and rubber resin are the preferred material overlaid with a waxed non-adhesive strip are suggested. However, the base 20 and center 10 and peel-off laminate strips 16 can consist of any other material that can be repeatedly bent, rolled, and straightened out without fracturing, such as various impregnated and laminated fibrous materials, various elasticized laminated materials, saturated crepe paper with an adhesive coating overlaid with a waxed or non-adhesive material, etc.

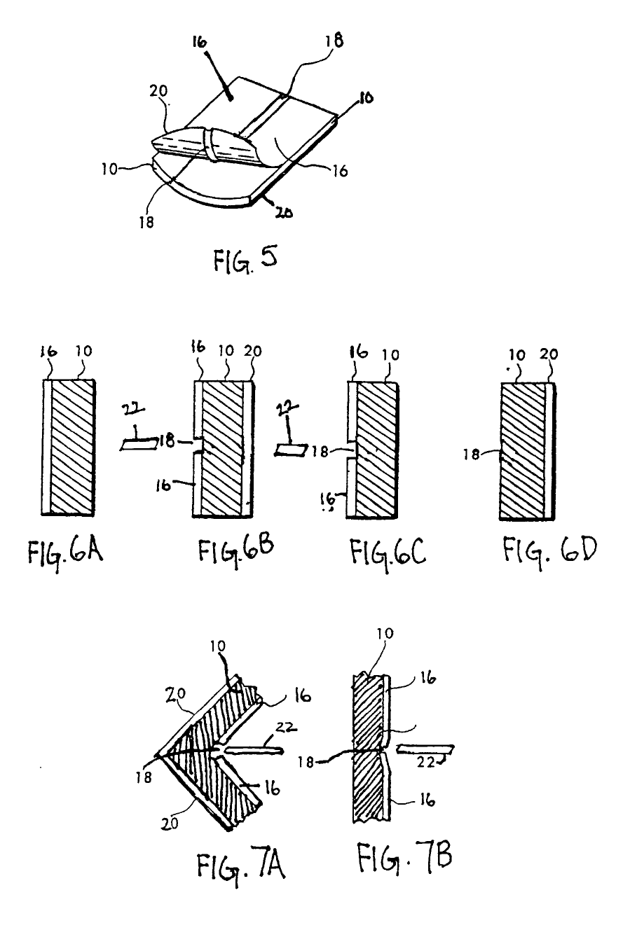

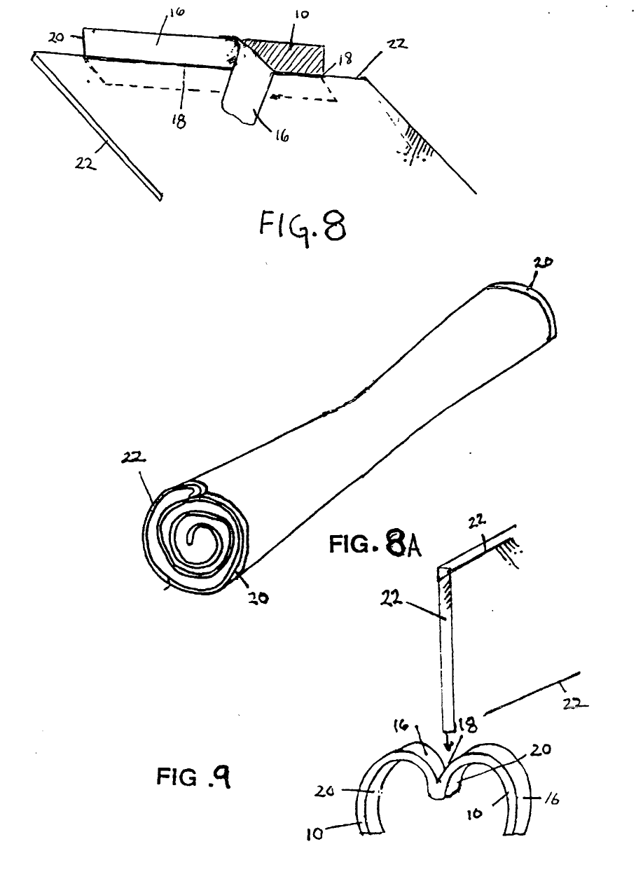

On the top edge of the tape section (FIG. 4) is a lead-in notch 18 which exposes an adhesive gap 10, centered, created by the two bordering peel-off strips 16 extending outward horizontally to the edges of the adhesive body 10 and backing 20 (FIG. 3). Peel-off laminate strips 16 and backing 20 adhere to the adhesive base 10 by virtue of the bonding material that comprises the entirety of the adhesive layer/compound applied by pressure and specific placement (FIGS. 2, 3, 4 and 5). Thus the lamination of the adhesive layer 10 and the backing material 20 will be of the same width and dimensions. The peel-off laminate strips 16 will also be the same width and dimensions (FIG. 2) but will be scored through the center to create a gap that will expose the adhesive layer 10 (FIGS. 3, 4, 5).

The backing layer 20 center adhesive layer 10 and peel-off laminate strips 16 are typically 0.18 mm to 0.22 mm in thickness, and have an overall width dimensions of ¾ inch to an 1 ½ inch, but may be otherwise. Also, when these tapes sections are connected side-to-side in a continuous roll for the preferred embodiment (blueprints) there will be two sections of thirty-eight (38) inches long, followed by a single tape section of thirty (30) inches, this positioning repeated throughout the entirety of the roll. These dimensions will be identical if the tape sections are manufactured in pre-cut sets. A longitudinal notch 18 is formed in the center of the laminate peel-off strips 16 in FIGS. 3, 4, and 5. Notch 18 may be formed by machining, scoring, cutting or any other pre-defined process. While this explains the dimensions of the preferred embodiment (blueprints), the lengths could vary depending on the product to be edged.

FIGS. 2-5—Additional Embodiments

Additional embodiments are shown in FIGS. 2, 3, 4, and 5; in each case the tape laminations are shown partially peeled back. In FIG. 2 the tape section has three laminations and no notch, in FIG. 3 it has three laminations and one centered cut notch; in FIG. 4 it has three laminations and the peeled-back lamination with the notch scored, the backing peeled down; in FIG. 5 it has three laminations and the peeled-back lamination with the notch scored.

FIGS. 6A, 6B, 6C, and 6D—Possible Embodiments

There are various possibilities with regard to the relative disposition of the sides which are notched and the sides that are used for backing, as illustrated in FIG. 6, which presents side views along longitudinal axis. FIG. 6A shows a tape section with a peel-off laminate without a notch bonded to an adhesive layer; FIG. 6B shows a tape section with a backing, and peel-off lamination having a center notch bonded to an adhesive layer with a product edge readied to be inserted; FIG. 6C shows a tape section with a peel-off lamination scored in the center bonded to an adhesive layer, with a product edge readied to be inserted; FIG. 6D shows a tape section with the adhesive layer bonded to the backing material

Advantages

From the description above, a number of advantages of our paper laminated tape strips become evident.

(a) A few rolls of tape stripping will conveniently adhere to a large project with many blueprint sheaves as well as a small job with one or two rolls, and can be carried from job to job like masking tape rolls.

(b) With the use of strip packets or rolls of taping strips, one can expect to fulfill a wide range of commercial uses, from use in architectural shops to blueprint design projects.

(c) The backing color acts as a color-coding tool as well as adds marketing value

(d) The pliability adds to the resilience of the product as well as the target item in that the product is still as useful as originally planned, i.e., rolling up and spreading out without an undue margin of added weight.

(e) The tape sections will provide a rough handled surface to easily grip and flatten out along a flat or vertical surface.

Operation—FIGS. 7, 8, 8A, 9

The manner of using the tape edging to code and bind product edges is similar to other tape binding processes, such as masking tape. Namely, one lays down a section of tape section flat, laminate peel-off strip 16 & notched adhesive side 18 facing up, non-adhesive side down 20. Next, one takes the product to be edged and presses it firmly into the adhesive notch slot 18 so that the product edge 22 is centered. Holding the product and gripping one end, right or left of center notch 18, of one of the peel-off laminate strips, peel-back the laminate strip to expose the adhesive layer 10 and press firmly onto the products horizontal edge so that the vertical edge and one side of the horizontal edge is wrapped and secure (FIG. 8). Next, grip the other peel-off laminate strip 16, right or left of center notch 18, by one end and again peel-back to expose the adhesive layer 10 and press firmly into place over the opposing horizontal edge that was wrapped first. Thus, both sides of the product edge 22 will be wrapped around the vertical edge and extending onto the horizontal edges, along upper and lower perimeters, allowing the notch 18 to act as a hinge to provide a consistent fold to both sides. As shown in FIGS. 7A and 7B (both side views), when the tape section is bent along its longitudinal region of the notch 18 and the corresponding adhesive body 10 and backing 20 will stretch along a direction perpendicular to the longitudinal axis, thereby creating a natural hinge to accept the product edge 22 and provide a even edging to both horizontal surfaces of the product and ensure a tight wrap. By creating this crease it is less likely that the application of the edging tape will be non-uniform or irregularly applied to both sides of the target product. FIG. 8A shows a set of plans rolled up with tape edging applied to the product edge 22, showing the flexibility of the edging as well as the backing surface 20, which can be used for marketing/advertising purposes. FIG. 9 shows an enlarged view of a tape edging section ready to be applied to a product surface, both vertically and horizontally. The edge of the paper/vellum/product 22 will be sandwiched between the upper and lower adhesive edges of said tape section into the notch securing the single vertical side edge of a paper/product perimeter, after the peel off laminate sections are pulled away. The adhesive area that is exposed after the laminate peel-off strips are removed will be bound to the paper by applying pressure to both the upper and lower surface of the paper/target articles to keep the strip bound securely.

The backing material will be of various colors to act as visual orientation for cataloging/reference for quick access and/or sight recognition. The backing material can also be used as a printing surface for marketing uses. The backing material will be of semi-rough texture to ensure ability to grasp.

Conclusion, Ramifications, and Scope

Accordingly, the reader will see that the tape sectional edging of this invention can be used to withstand wear and tear of blueprints, can be used to color code construction segments of the blueprints, and can provide flexibility without impairing the ability to roll and unroll plans. In addition, the colored backing can be used for marketing purposes. The notched adhesion flanked by the peel-off laminate sections creates a hinge for the vertical edge of the blueprint so as to provide consistent applications of the invention to the intended paper surface. Furthermore, the tape sectional strips has the additional advantages in that

it permits the production of the tape strips in a variety of colors in rolls which are easy to transport and consume less space;

it permits an immediate stability to the paper structure of blueprints which provides a cost effective way to prolong the usefulness of the blueprint;

it provides a edge with a added improved surface upon which one can print or label;

it provides a edge that will not become slippery when handled with wet or soiled fingers, the tape providing a non-slip surface opposed to the slick structure of blueprint vellum

Although the description above contains many specificities, these should not be construed as limiting the scope of the invention but as merely providing illustrations of some of the presently preferred embodiments of this invention. For example, the tape sectionals can be manufactured in rolls with in pre-cut lengths, two long sided tapes and one short end sectional, to be followed immediately with another pre-cut grouping matching the preceding one and so forth through the entire roll. The color scheme can be changed, depending on the marketing target that the tape is being produced for, could be used to edge other products that require color coding and/or a cataloging method, i.e., edging different sizes of cut glass in order to quickly identify their dimensions without physically touching them, etc

Thus the scope of the invention should be determined by the appended claims and their legal equivalents, rather than by the examples given herein.

What is claimed is:

1. A roll of adhesive stripping tape for being cut into segments to form marginal edging for application to blueprint sheets or products such as manuscript pages or cut glass, said tape having opposite first and second major surfaces defined by side-by-side, longitudinally-extending first and second portions of said tape, said first and second portions being integral with each other with a pre-defined notch in the center, used as a receiving means for receiving paper edge on at least one of the opposite major surfaces along said first portion, said second portion being use to wrap along the opposite surface, and said tape having a layer of adhesive on the first opposite major surface along said second portion, which layer of adhesive, when the tape is pulled off the roll and cut to form a tape segment for use as a marginal edge, will bond the second portion of the tape segment to a sheet at one edge of the sheet with the first portion of the tape segment projecting laterally from the edge of the sheet in a position to display tear-away laminate on said first portion, said first portion and said second portion having a uniform thickness measured normal to the opposite major surfaces across the width of the tape.

2. A roll of adhesive stripping tape forming tape according to claim 1, wherein said tape has receiving means for receiving blueprint edges on both of the opposite major surfaces along said first portion.

3. A roll of adhesive stripping tape forming tape according to claim 1 including peel-away laminates on both of the opposite major surfaces along said first portion to provide said receiving means for receiving blueprint edges on both of the opposite major surfaces along said first portion.

4. A roll of adhesive stripping tape forming tape according to claim 3, wherein said coatings are adhesive coatings on both of the opposite major surfaces with peel-away laminate strips along said first portion.

5. A roll of adhesive stripping tape according to clam 1, wherein said tape includes a coating on at least one of the opposite major surfaces along said first portion to provide said receiving means for receiving blueprint edges on at least one of the opposite major surfaces along said first portion.

6. A roll of adhesive stripping tape according to claim 5, wherein said coating is a adhesive coating on at least one of the opposite major surfaces along said first portion.

7. A roll of adhesive stripping tape according to claim 1, wherein said first and second portions of the tape are of substantially equal width

8. A roll of adhesive stripping tape according to claim 1, wherein the tape has receiving adhesive notch for receiving blueprint edges on one of the opposite major surfaces along said first portion.

9. A roll of adhesive stripping tape according to claim 1, wherein said second portion is of equal dimension and construction.

10. A roll of adhesive stripping tape according to claim 1, wherein said second portion is layered with a peel-away laminate strip and forms a center notch that exposes a adhesive patch that sets a uniform valley to accept the vertical edge of the blueprint vellum edge.

11. The roll of adhesive stripping tape according to claim 1, wherein the tape is a plastic, cloth and/or masking tape.

12. The roll of adhesive stripping tape according to claim 1, wherein the layer of adhesive bonds each tape segment to a sheet after being exposed by use of a pull-away laminate strip, wherein the layer of adhesive permanently bonds each tape segment to a sheet.

13. A roll of adhesive stripping tape comprising a flexible cloth, masking and/or plastic tape having a first major side and a second, opposite major side, first and second longitudinally extending separate portions being defined on the tape separated by a center notch formed by two peel-away laminate strips, a coating capable of receiving blueprint edges thereon extending along the first portion on at least one of the sides of the tape, a layer of adhesive extending along the second portion on the first side of the tape, the second portion of the tape being equal in dimension and construction as the first portion, and the first portion and the second portion having a uniform thickness measured normal to the sides across the width of the tape, wherein the tape is capable of being pulled off the roll and cut into a plurality of tape segments for use as marginal edging with the layer of adhesive bonding the second portion of the tape segment to a sheet and the first portion of the tape segment wrapping around the edge of the sheet to adhere to the product edge and any blueprint edges thereon.

14. The roll of adhesive stripping tape of claim 14 wherein the edge is a vertical blueprint edge and/or paper edge such as a document.

15. The roll of adhesive stripping tape of claim 14 wherein the color coding is on the first side of the tape.

16. The roll of adhesive stripping tape of claim 16 and further comprising a notch comprised of two peel-away laminate strips that nearly meet in the center of the first and second portion capable of receiving blueprint edges extending along the first portion of at least one of the sides of the tape.

17. The roll of adhesive stripping tape of claim 16 wherein the second portion is a covered by a peel-away laminate strip to adhere to the opposite paper edge as the first portion

18. The roll of adhesive stripping tape of claim 14 wherein the blueprint edges can be written on the coating by pen or pencil or marking instrument

19 A protective element for blueprints, architectural drawings, comprising, a body element, a pair of peel off laminate strips, said pair of peel-off laminate strips being fastened or secured to said element and a notch, said being centrally positioned on said body element.
